(19) United States
(12) Patent Application Publication
(10) Pub. No.: US 2013/0076631 A1
(43) Pub. Date: Mar. 28, 2013

(54) INPUT DEVICE FOR GENERATING AN INPUT INSTRUCTION BY A CAPTURED KEYBOARD IMAGE AND RELATED METHOD THEREOF

(71) Applicants: Ren Wei Zhang, New Taipei City (TW); Ming xing Ji, New Taipei City (TW)

(72) Inventors: Ren Wei Zhang, New Taipei City (TW); Ming xing Ji, New Taipei City (TW)

(21) Appl. No.: 13/531,576

(22) Filed: Jun. 24, 2012

(30) Foreign Application Priority Data
Sep. 22, 2011 (CN) 201110282984.3

(51) Int. Cl. G06F 3/02

(52) U.S. Cl. 345/168

(57) ABSTRACT

An input device for generating an input instruction by captured images is disclosed. The input device includes a first image capturing module, a second image capturing module and a logic control unit. The first image capturing module and the second image capturing module are disposed around a keyboard for respectively capturing a first object image and a second object image of an object and for respectively capturing a first key image and a second key image of a key on the keyboard. The logic control unit is used for calculating a first distance according to the first object image and the first key image and a second distance according to the second object image and the second key image, and for generating the input instruction when the first distance and the second distance are smaller than a first threshold value and a second threshold value, respectively.

### BACKGROUND OF THE INVENTION

1. Field of the Invention

The present invention relates to an input device and a related method thereof, and more particularly, to an input device for generating an input instruction by a captured keyboard image and a related method thereof.

2. Description of the Prior Art

A keyboard, which is the most common input device, can be found in variety of electronic equipments for users to input characters, symbols, numerals and so on. From consumer electronic products to industrial machine tools are all equipped with a keyboard for purpose of operation. However, a conventional keyboard has concrete structures and occupies a spatial volume. When the conventional keyboard is not in use, it needs a containing space, resulting in inconvenience in use.

### SUMMARY OF THE INVENTION

Thus, the present invention provides an input device for generating an input instruction by a captured keyboard image and a related method thereof for solving above drawbacks.

According to the claimed invention, an input device for generating an input instruction by utilizing a captured keyboard image includes a first image capturing module, a second image capturing module and a logic control unit. The first image capturing module is disposed around a keyboard for capturing a first object image of an object and a first key image of a key on the keyboard. The second image capturing module is disposed around the keyboard for capturing a second object image of the object and a second key image of the key on the keyboard. The logic control unit is for calculating a first distance according to the first object image and the first key image and a second distance according to the second object image and the second key image, and further for generating the input instruction when determining that the first distance and the second distance are respectively smaller than a first threshold value and a second threshold value.

According to the claimed invention, the input device further includes a first portable electronic device, a second portable electronic device. The first image capturing module is disposed in the first portable electronic device. The second image capturing module is disposed is disposed in the second portable electronic device. The logic control unit is coupled to the first image capturing module and generates the input instruction when determining that the first distance and the second distance are respectively smaller than the first threshold value and the second threshold value.

According to the claimed invention, the first threshold value is substantially identical to the second threshold value.

According to the claimed invention, the first portable electronic device includes a first wireless communication module, the second portable electronic device includes a second wireless communication module, and the second wireless communication module communicates with the first wireless communication module for transmitting image data.

According to the claimed invention, the logic control unit generates a first object coordinate and a first key coordinate respectively according to the first object image and the first key image, the logic control unit further generates a second object coordinate and a second key coordinate respectively according to the second object image and the second key image, and the logic control unit calculates the first distance according to the first object coordinate and the first key coordinate and further calculates the second distance according to the second object coordinate and the second key coordinate.

According to the claimed invention, an included angle is defined between a line connecting the first image capturing module and the keyboard and a line connecting the second image capturing module and the keyboard.

According to the claimed invention, the input device further includes a portable electronic device. The first image capturing module and the second image capturing module are disposed in the portable electronic device. The logic control unit is coupled to the first image capturing module and the second image capturing module and generates the input instruction when determining that the first distance and the second distance are respectively smaller than the first threshold value and the second threshold value.

According to the claimed invention, a method for generating an input instruction by captured images includes utilizing a first image capturing module to capture a first object image of an object and a first key image of a key on a keyboard; utilizing a second image capturing module to capture a second object image of the object and a second key image of the key on the keyboard; a logic control unit calculating a first distance according to the first object image and the first key image and a second distance according to the second object image and the second key image; and the logic control unit generating the input instruction when determining that the first distance and the second distance are respectively smaller than a first threshold value and a second threshold value.

According to the claimed invention, the method further includes disposing the first image capturing module and the second image module respectively in a first portable electronic device and in a second portable electronic device. The logic control unit is coupled to the first image capturing module. The method further includes utilizing a first wireless communication module of the first portable electronic device to communicate with a second wireless communication module of the second portable electronic device to transmit image data.

According to the claimed invention, the method further includes utilizing the logic control unit to generate a first object coordinate and a first key coordinate respectively according to the first object image and the first key image; and utilizing the logic control unit to generate a second object coordinate and a second key coordinate respectively according to the second object image and the second key image.

According to the claimed invention, the logic control unit calculating the first distance according to the first object image and the first key image and the second distance according to the second object image and the second key image includes the logic control unit calculating the first distance according to the first object coordinate and the first key coordinate and further calculating the second distance according to the second object coordinate and the second key coordinate.

According to the claimed invention, the method further includes disposing the first image capturing module and the second image module in a portable electronic device. The logic control unit is coupled to the first image capturing module and the second image capturing module.

In summary, the present invention utilizes the image capturing modules to capture the object images of the object and the key images of the key, the logic control unit to calculate the distances between the object images and key images to determine whether the keyboard is activated. In such a manner, the present invention is capable of visualizing a keyboard for a user to operate. In other words, the above visualized keyboard can be a paper with a keyboard pattern, that is, the above visualized keyboard can not be a concrete keyboard with keyswiches, a base, a circuit board and so on. Accordingly, the input device of the present invention does not occupy a space . Without any containing space required to contain the input device of the present invention, the user can only turn off the portable electronic device equipped with the image capturing modules and the logic control unit when the input device of the present invention is not in use. In such a manner, the input device of the present invention can enhance convenience in use.

These and other objectives of the present invention will no doubt become obvious to those of ordinary skill in the art after reading the following detailed description of the embodiment that is illustrated in the various figures and drawings.

### BRIEF DESCRIPTION OF THE DRAWINGS

FIG. 1 is a functional block diagram of an input device according to a first embodiment of the present invention.

FIG. 2 is a diagram of the input device in an in-use status according to the first embodiment of the present invention.

FIG. 3 is a diagram of an image captured by a first image capturing module according to the first embodiment of the present invention.

FIG. 4 is a diagram of an image captured by a second image capturing module according to the first embodiment of the present invention.

FIG. 5 is a flowchart of the method according to the first embodiment of the present invention.

FIG. 6 is a functional block diagram of an input device according to a second embodiment of the present invention.

FIG. 7 is a flowchart of the method according to the second embodiment of the present invention.

### DETAILED DESCRIPTION

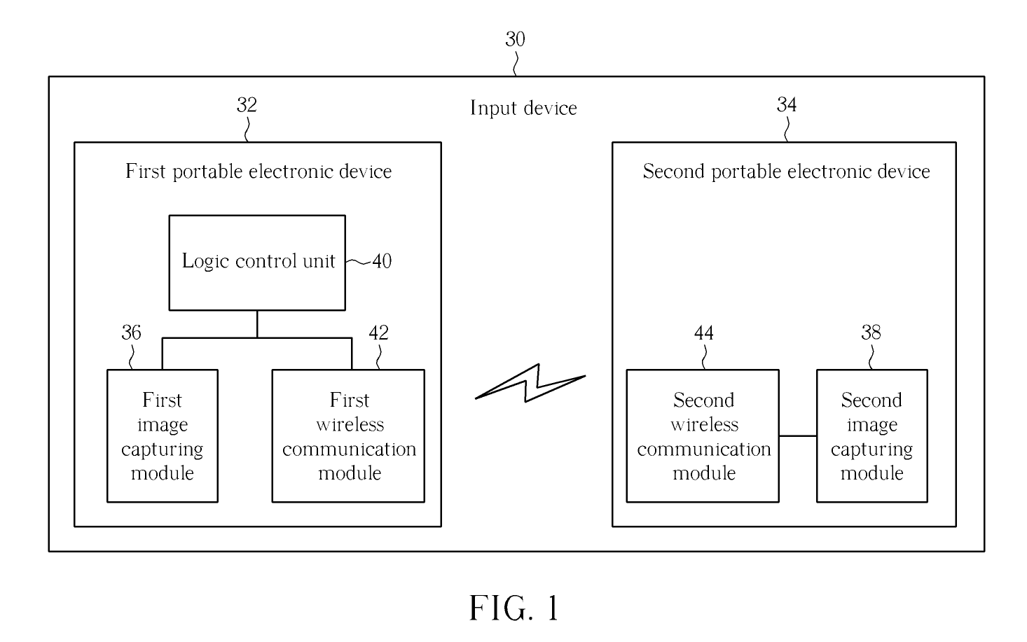

Please refer to FIG. 1. FIG. 1 is a functional block diagram of an input device 30 according to a first embodiment of the present invention. As shown in FIG. 1, the input device 30 includes a first portable electronic device 32, a second portable electronic device 34, a first image capturing module 36 and a second image capturing module 38. The first image capturing module 36 and the second image capturing module 38 are disposed in the first portable electronic device 32 and the second portable electronic device 34, respectively. In practical application, the first portable electronic device 32 can be a notebook computer with an image capturing module, such as a webcam and so on, and the second portable electronic device 34 can be a mobile phone with an image capturing module, such as a camera module. The application of the present invention is not limited to those mentioned above. For example, the first portable electronic device 32 can also be a notebook computer or a tablet computer with the first image capturing module 36 and the second image capturing module 38. In other words, the computer devices with the image capturing modules are within the scope of the present invention.

Furthermore, the input device 30 further includes a logic control unit 40, the first portable electronic device 32 includes a first wireless communication module 42, and the second portable electronic device 34 includes a second wireless communication module 44. The logic control unit 40 is coupled to the first image capturing module 36 and the second wireless communication module 42, and the second image capturing module 38 is coupled to the second wireless communication module 44. The second wireless communication module 44 is used for communicating with the first wireless communication module 42, so as to transmit image data captured by the second image capturing module 38 of the second portable electronic device 34 to the logic control unit 40 of the first portable electronic device 32. In the first embodiment, the first wireless communication module 42 and the second wireless communication module 44 can be, but not limited to, a bluetooth module, respectively. For example, the first wireless communication module 42 and the second wireless communication module 44 can be respectively an infrared transmission module as well.

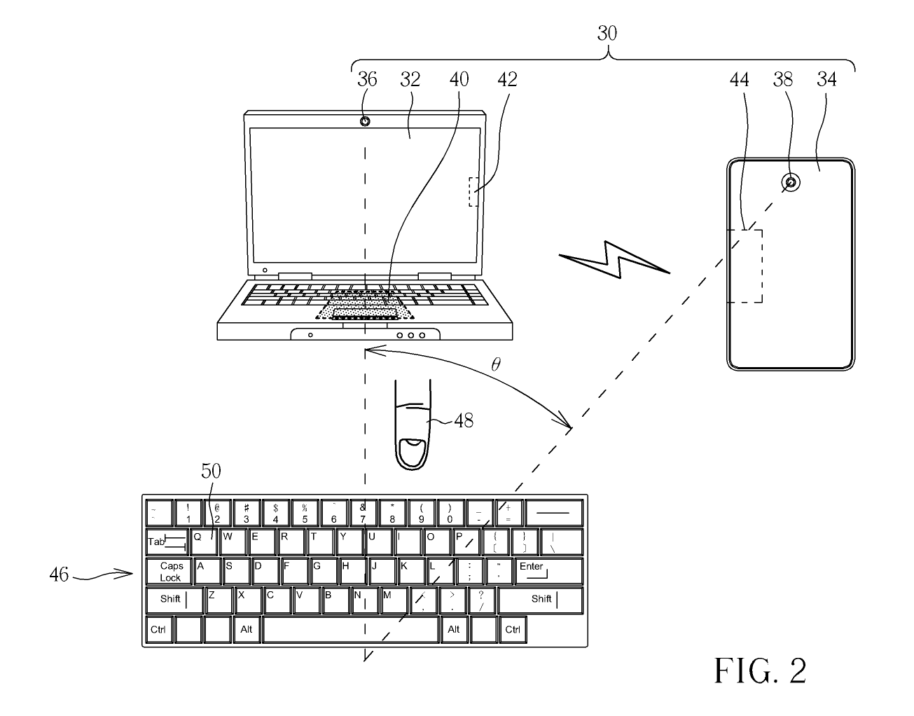

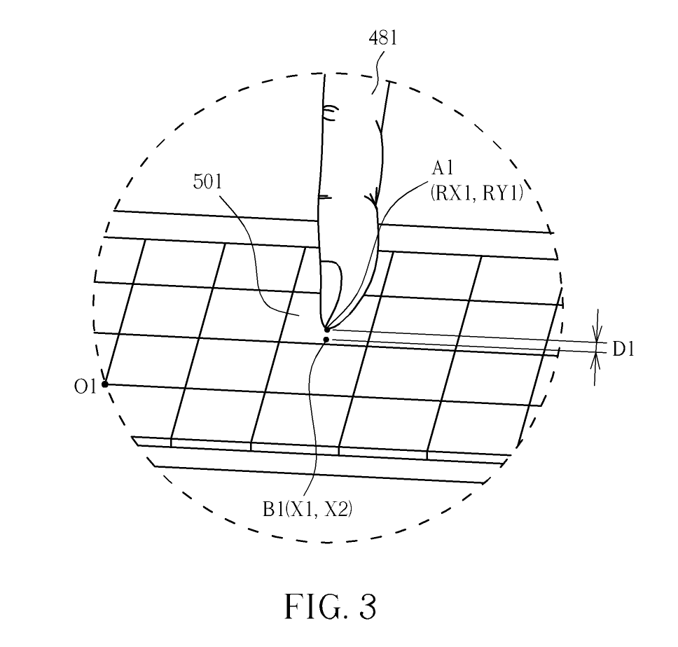

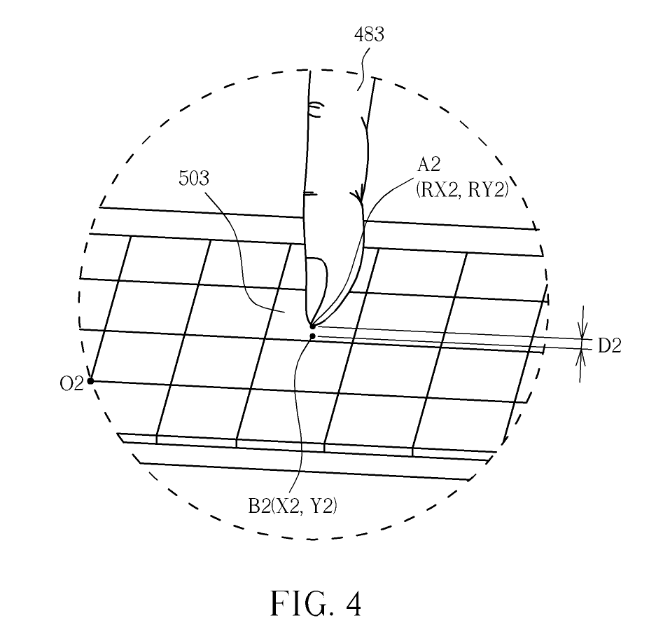

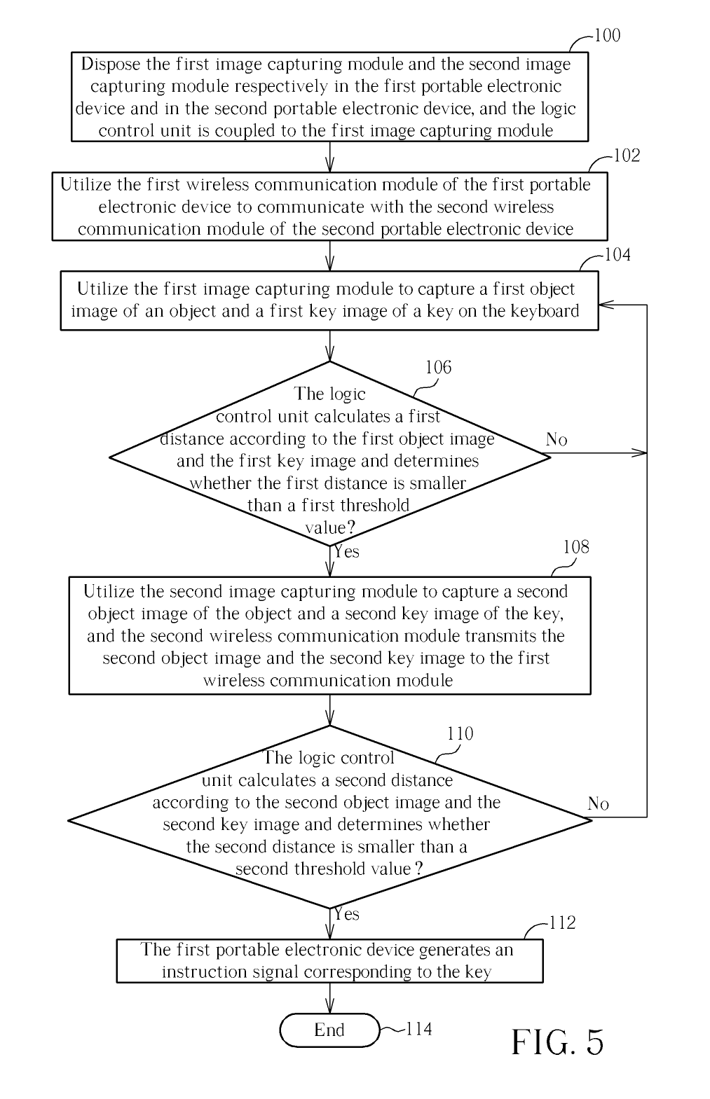

Please refer to FIG. 2 to FIG. 4. FIG. 2 is a diagram of the input device 30 in an in-use status according to the first embodiment of the present invention. FIG. 3 is a diagram of an image captured by the first image capturing module 36 according to the first embodiment of the present invention. FIG. 4 is a diagram of an image captured by the second image capturing module 38 according to the first embodiment of the present invention. As shown in FIG. 2 to FIG. 4, the first portable electronic device 32 and the second portable electronic device 34 are disposed nearby a keyboard 46. More detailed description of a method for generating an input instruction by captured images of the keyboard 46 is provided as follows. Please refer to FIG. 5 as well. FIG. 5 is a flowchart of the method according to the first embodiment of the present invention. The method includes following steps:

Step 100: Dispose the first image capturing module 36 and the second image capturing module 38 respectively in the first portable electronic device 32 and in the second portable electronic device 34, and the logic control unit 40 is coupled to the first image capturing module 36.

Step 102: Utilize the first wireless communication module 42 of the first portable electronic device 32 to communicate with the second wireless communication module 44 of the second portable electronic device 34.

Step 104: Utilize the first image capturing module 36 to capture a first object image 481 of an object 48 and a first key image 501 of a key 50 on the keyboard 46.

Step 106: The logic control unit 40 calculates a first distance D1 according to the first object image 481 and the first key image 501 and determines whether the first distance D1 is smaller than a first threshold value. If yes, go to Step 108; if no, return to Step 104.

Step 108: Utilize the second image capturing module 38 to capture a second object image 483 of the object 48 and a second key image 503 of the key 50, and the second wireless communication module 44 transmits the second object image 483 and the second key image 503 to the first wireless communication module 42.

Step 110: The logic control unit 40 calculates a second distance D2 according to the second object image 483 and the second key image 503 and determines whether the second distance D2 is smaller than a second threshold value. If yes, go to Step 112; if no, return to Step 104.

Step 112: The first portable electronic device 32 generates an instruction signal corresponding to the key 50.

Step 114: End.

In the first embodiment, two portable electronic devices, i.e. the first portable electronic device 32 and the second portable electronic device 34, and two image capturing modules, i.e. the first image capturing module 36 and the second image capturing module 38, are used for implementing the input device 30 of the present invention. In step 100, the first image capturing module 36 and the second image capturing module 38 are respectively disposed in the first portable electronic device 32 and in the second portable electronic device 34. The logic control unit 40 is coupled to the first image capturing module 36 and the first wireless communication module 42, and the second image capturing module 38 is coupled to the second wireless communication module 44.

In addition, since the logic control unit 40 is coupled to the first image capturing module 36 and is used for processing the above-mentioned images, the first portable electronic device 32 and the second portable electronic device 34 need to respectively include the first wireless communication module 42 and the second wireless communication module 44, such that the images captured by the second image capturing module 38 can be transmitted to the first wireless communication module 42 of the first portable electronic device 32. In the first embodiment, the first wireless communication module 42 of the first portable electronic device 32 is utilized to communicate with the second wireless communication module 44 of the second portable electronic device 34, so as to transmit image data (Step 102).

Furthermore, the first image capturing module 36 is used for capturing the first object image 481 of the object 48 and the first key image 501 of the key 50 on the keyboard 46 (Step 104). Then, the logic control unit 40 can process the image for the first object image 481 so as to generate a first object coordinate (RX1, RY1) and a first key coordinate (X1, Y1) respectively according to a tip point A1 of the first object image 481 relative to a first origin O1 set therein and according to a contacting point B1 of the first key image 501 relative to the first origin O1. In addition, the logic control unit 40 can calculate the first distance D1 according to the first object coordinate (RX1, RY1) and the first key coordinate (X1, Y1), as shown in FIG. 3.

Then, the logic control unit 40 determines whether the first distance D1 obtained by the above-mentioned method is smaller than the first threshold value (Step 106). If the logic control unit 40 determines the first distance D1 is greater than the first threshold value, return to Step 104, that is, the logic control unit 40 controls the first image capturing module 36 to be continuously capturing the first object image 481 of the object 48 and the first key image 501 of the key 50 on the keyboard 46. On the other hand, if the logic control unit 40 determines that the first distance D1 is smaller than the first threshold value, go to Step 108. In other words, the second image capturing module 38 is used for capturing the second object image 483 of the object 48 and the second key image 503 of the key 50, and the second wireless communication module 44 transmits the second object image 483 and the second key image 503 to the first wireless communication module 42.

Similarly, the logic control unit 40 can generate a second object coordinate (RX2, RY2) and a second key coordinate (X2, Y2) respectively according to a tip point A2 of the second object image 483 relative to a second origin O2 set therein and according to a contacting point B2 of the second key image 503 relative to the second origin O2. In addition, the logic control unit 40 can calculate the second distance D2 according to the second object coordinate (RX2, RY2) and the second key coordinate (X2, Y2), as shown in FIG. 4. Then, the logic control unit 40 can determine whether the second distance D2 is smaller than the second threshold value (Step 110). If the logic control unit 40 determines the second distance D2 is greater than the second threshold value, return to Step 104, that is, the logic control unit 40 controls the first image capturing module 36 to be continuously capturing the first object image 481 of the object 48 and the first key image 501 of the key 50 on the keyboard 46. On the other hand, if the logic control unit 40 determines that the second distance D2 is smaller than the second threshold value, go to Step 112. In other words, the logic control unit 40 is used for outputting the instruction signal to the first portable electronic device 32. For example, the first portable electronic device 32 can display an input message on a display device of the first portable electronic device 32. For example, when the key 50 being pressed is a character key, a character icon corresponding to the key 50 is shown on the display device of the first portable electronic device 32. In summary, as long as at least one of the first distance D1 and the second distance D2 is greater than the corresponding threshold values, the logic control unit 40 does not output the instruction signal to the first portable electronic device 32, that is, there is no input message shown on the display device of the first portable electronic device 32.

It should be noticed that relation between the first distance D1, the first object coordinate (RX1, RY1) and the first key coordinate (X1, Y1) and relation between the second distance D2, the second object coordinate (RX2, RY2) and the second key coordinate (X2, Y2) can be derived by the following formulae:

D2=√(X2−RX2)̂2+(Y2−RY2)̂2 (1)

D2=√(X2−RX2)̂2+(Y2−RY2)̂2 (2)

In the first embodiment, the first threshold value can be, but not limited to, substantially identical to the second threshold value. For example, the first threshold value can be different from the second threshold value. As for adopting which one of the above-mentioned designs, it depends on practical demands. In addition, the first portable electronic device 32 and the second portable electronic device 34 are disposed nearby the keyboard 46, and the first image capturing module 36 and the second image capturing module 38 are disposed in the first portable electronic device 32 and in the second portable electronic device 34, respectively. An included angle θ is defined between a line connecting the first image capturing module 36 and the keyboard 46 and a line connecting the second image capturing module 38 and the keyboard 46, as shown in FIG. 2. Thus, the first object coordinate (RX1, RY1) and the first key coordinate (X1, Y1) generated by the first image capturing module 36 are respectively different from the second object coordinate (RX2, RY2) and the second key coordinate (X2, Y2) generated by the second image capturing module 38. In other words, images of the object 48 captured by the first image capturing module 36 and the second image capturing module 38 are located in two planes with a specific angle formed therebetween, so as to form a special image. When a distance between the image of the object 48 and the image of the key 50 on a specific plane is within a specific range and when a distance between the image of the object 48 and the image of the key 50 on another specific plane is within a specific range as well, it is thought that the object 48 has reached the key 50 in space, meaning that the key 50 is pressed by the object 48. Accordingly, via calculation of formula (1) and formula (2), the logic control unit 40 can determine whether the first distance D1 and the second distance D2 are respectively smaller than the first threshold value and the second threshold value more precisely, so as to determine whether the object 48 activates the key 50 more precisely. In addition, the present invention can utilizes multiple, i.e. more than two, image capturing modules to capture object images and key images for determining whether the object 48 activates the key 50. In other words, the present invention can determine whether the object 48 activates the key 50 by whether distances between the object images and the key images respectively captured by the multiple image capturing modules are smaller than the specific values. Since the principle is similar to that mentioned in the above-mentioned embodiment, further description is omitted herein for simplicity.

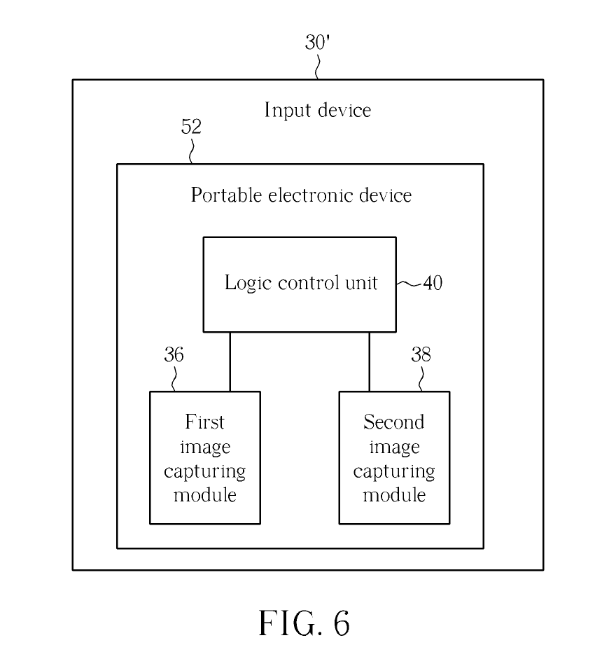

Please refer to FIG. 1 and FIG. 6. FIG. 6 is a functional block diagram of an input device 30′ according to a second embodiment of the present invention. As shown in FIG. 1 and FIG. 6, the main difference between the input device 30′ and the aforesaid input device 30 is that the input device 30′ only includes a portable electronic device 52, the first image capturing module 36 and the second image capturing module 38 are disposed in the portable electronic device 52, and the logic control unit 40 is coupled to the first image capturing module 36 and the second image capturing module 38. In addition, since the input device 30′ only includes a single portable electronic device, the input device 30′ does not need to transmit image data among different devices. Accordingly, the input device 30′ does not need to include the wireless communication modules. The logic control unit 40 of the input device 30′ can directly obtain the first object image 481, the first key image 501, the second object image 483 and the second key image 503, so as to generate the first object coordinate (RX1, RY1), the first key coordinate (X1, Y1), the second object coordinate (RX2, RY2) and the second key coordinate (X2, Y2). Components with the same denotes in FIG. 1 and FIG. 6 have the same structures and functions, so further description is omitted herein for simplicity.

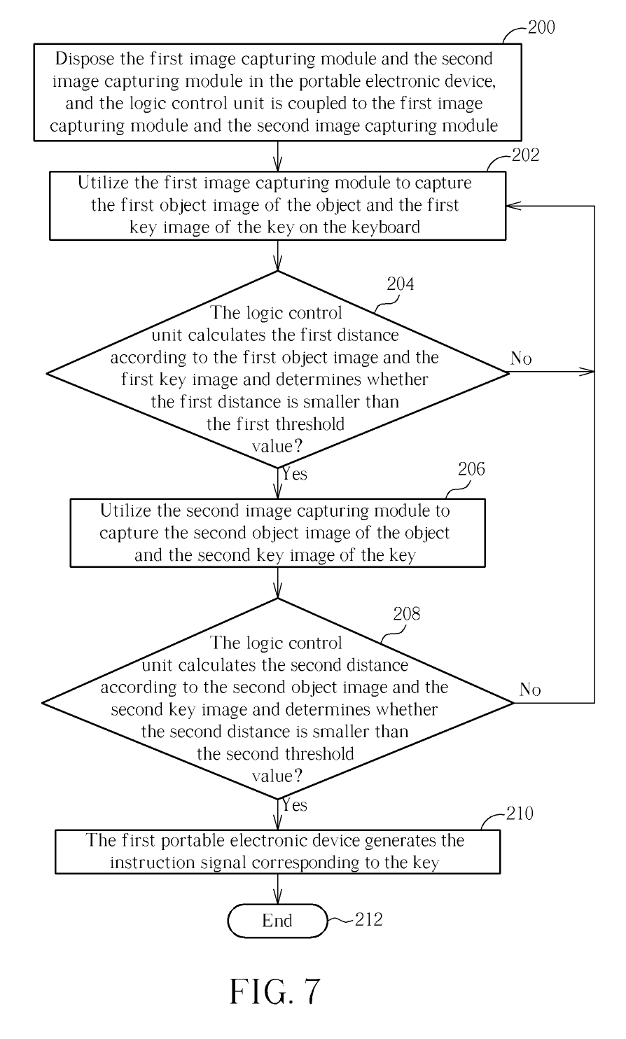

Please refer to FIG. 5 and FIG. 7. FIG. 7 is a flowchart of the method according to the second embodiment of the present invention. The method includes following steps:

Step 200: Dispose the first image capturing module 36 and the second image capturing module 38 in the portable electronic device 52, and the logic control unit 40 is coupled to the first image capturing module 36 and the second image capturing module 38.

Step 202: Utilize the first image capturing module 36 to capture the first object image 481 of the object 48 and the first key image 501 of the key 50 on the keyboard 46.

Step 204: The logic control unit 40 calculates the first distance D1 according to the first object image 481 and the first key image 501 and determines whether the first distance D1 is smaller than the first threshold value. If yes, go to Step 206; if no, return to Step 202.

Step 206: Utilize the second image capturing module 38 to capture the second object image 483 of the object 48 and the second key image 503 of the key 50.

Step 208: The logic control unit 40 calculates the second distance D2 according to the second object image 483 and the second key image 503 and determines whether the second distance D2 is smaller than the second threshold value. If yes, go to Step 210; if no, return to Step 204.

Step 210: The first portable electronic device 32 generates the instruction signal corresponding to the key 50.

Step 212: End.

As shown in FIG. 5 and FIG. 7, the main difference between the second embodiment and the first embodiment is that the first image capturing module 36 and the second image capturing module 38 are disposed in the single portable electronic device 52 according to the second embodiment. Furthermore, the logic control unit 40 is directly coupled to the first image capturing module 36 and the second image capturing module 38 (Step 200). In other words, the logic control unit 40 directly processes the image data captured by the first image capturing module 36 and the second image capturing module 38. Accordingly, the second embodiment does not require the wireless communication modules. That is, the method according to the second embodiment can omit Step 102 in the flowchart of the method according to the first embodiment. Other steps of the method according to the second embodiment are identical to those mentioned in the first embodiment, so further description is omitted herein for simplicity.

In contrast to the prior art, the present invention utilizes the image capturing modules to capture the object images of the object and the key images of the key, the logic control unit to calculate the distances between the object images and key images to determine whether the keyboard is activated. In such a manner, the present invention is capable of visualizing a keyboard for a user to operate. In other words, the above visualized keyboard can be a paper with a keyboard pattern, that is, the above visualized keyboard can not be a concrete keyboard with key switches, a base, a circuit board and so on. Accordingly, the input device of the present invention does not occupy a space. Without any containing space required to contain the input device of the present invention, the user can only turn off the portable electronic device equipped with the image capturing modules and the logic control unit when the input device of the present invention is not in use. In such a manner, the input device of the present invention can enhance convenience in use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An input device for generating an input instruction by captured images, comprising:
a first image capturing module disposed around a keyboard for capturing a first object image of an object and a first key image of a key on the keyboard;
a second image capturing module disposed around the keyboard for capturing a second object image of the object and a second key image of the key on the keyboard; and
a logic control unit for calculating a first distance according to the first object image and the first key image and a second distance according to the second object image and the second key image, and further for generating the input instruction when determining that the first distance and the second distance are respectively smaller than a first threshold value and a second threshold value.

2. The input device of claim 1, further comprising:
a first portable electronic device wherein the first image capturing module is disposed; and
a second portable electronic device wherein the second image capturing module is disposed;
wherein the logic control unit is coupled to the first image capturing module and generates the input instruction when determining that the first distance and the second distance are respectively smaller than the first threshold value and the second threshold value.

3. The input device of claim 2, wherein the first threshold value is substantially identical to the second threshold value.

4. The input device of claim 2, wherein the first portable electronic device comprises a first wireless communication module, the second portable electronic device comprises a second wireless communication module, and the second wireless communication module communicates with the first wireless communication module for transmitting image data.

5. The input device of claim 4, wherein the logic control unit generates a first object coordinate and a first key coordinate respectively according to the first object image and the first key image, the logic control unit further generates a second object coordinate and a second key coordinate respectively according to the second object image and the second key image, and the logic control unit calculates the first distance according to the first object coordinate and the first key coordinate and further calculates the second distance according to the second object coordinate and the second key coordinate.

6. The input device of claim 5, wherein an included angle is defined between a line connecting the first image capturing module and the keyboard and a line connecting the second image capturing module and the keyboard.

7. The input device of claim 6, wherein the first threshold value is substantially identical to the second threshold value.

8. The input device of claim 1, further comprising:
a portable electronic device wherein the first image capturing module and the second image capturing module are disposed;
wherein the logic control unit are coupled to the first image capturing module and the second image capturing module and generates the input instruction when determining that the first distance and the second distance are respectively smaller than the first threshold value and the second threshold value.

9. The input device of claim 8, wherein the first threshold value is substantially identical to the second threshold value.

10. The input device of claim 8, wherein the logic control unit generates a first object coordinate and a first key coordinate respectively according to the first object image and the first key image, the logic control unit further generates a second object coordinate and a second key coordinate respectively according to the second object image and the second key image, and the logic control unit calculates the first distance according to the first object coordinate and the first key coordinate and calculates the second distance according to the second object coordinate and the second key coordinate.

11. The input device of claim 10, wherein an included angle is defined between a line connecting the first image capturing module and the keyboard and a line connecting the second image capturing module and the keyboard.

12. The input device of claim 11, wherein the first threshold value is substantially identical to the second threshold value.

13. A method for generating an input instruction by captured images, comprising:
utilizing a first image capturing module to capture a first object image of an object and a first key image of a key on a keyboard;
utilizing a second image capturing module to capture a second object image of the object and a second key image of the key on the keyboard;
a logic control unit calculating a first distance according to the first object image and the first key image and a second distance according to the second object image and the second key image; and
the logic control unit generating the input instruction when determining that the first distance and the second distance are respectively smaller than a first threshold value and a second threshold value.

14. The method of claim 13, further comprising:
disposing the first image capturing module and the second image module respectively in a first portable electronic device and in a second portable electronic device, wherein the logic control unit is coupled to the first image capturing module; and
utilizing a first wireless communication module of the first portable electronic device to communicate with a second wireless communication module of the second portable electronic device to transmit image data.

15. The method of claim 14, further comprising:
utilizing the logic control unit to generate a first object coordinate and a first key coordinate respectively according to the first object image and the first key image; and
utilizing the logic control unit to generate a second object coordinate and a second key coordinate respectively according to the second object image and the second key image.

16. The method of claim 15, wherein the logic control unit calculating the first distance according to the first object image and the first key image and the second distance according to the second object image and the second key image comprises the logic control unit calculating the first distance according to the first object coordinate and the first key coordinate and further calculating the second distance according to the second object coordinate and the second key coordinate.

17. The method of claim 16, wherein the first threshold value is substantially identical to the second threshold value.

18. The method of claim 13, further comprising:
disposing the first image capturing module and the second image module in a portable electronic device, wherein the logic control unit is coupled to the first image capturing module and the second image capturing module.

19. The method of claim 18, further comprising:
utilizing the logic control unit to generate a first object coordinate and a first key coordinate respectively according to the first object image and the first key image; and
utilizing the logic control unit to generate a second object coordinate and a second key coordinate respectively according to the second object image and the second key image.

20. The method of claim 19, wherein the logic control unit calculating the first distance according to the first object image and the first key image and the second distance according to the second object image and the second key image comprises the logic control unit calculating the first distance according to the first object coordinate and the first key coordinate and further calculating the second distance according to the second object coordinate and the second key coordinate.
